(19) United States
(12) Patent Application Publication
(10) Pub. No.: US 2007/0168566 A1
(43) Pub. Date: Jul. 19, 2007

(54) Memory card with an indicator light

(75) Inventors: Kun-Hsien Hsiao, Chung Ho City (TW); Yen-Jung Feng, Chung Ho City (TW); Min-Hao Hsu, Chung Ho City (TW)

Correspondence Address: BACON & THOMAS, PLLC, 625 SLATERS LANE, FOURTH FLOOR, ALEXANDRIA, VA, 22314, US

(73) Assignee: Chip Hope Co., Ltd., Taipei Hsien (TW)

(21) Appl. No.: 11/267,144

(22) Filed: Nov. 7, 2005

(51) Int. Cl. G06F 3/00

(52) U.S. Cl. 710/2

(57) ABSTRACT

A memory card with an indicator light has a casing, a processor, an input/output (I/O) interface, memory and an indicator light module. The indicator light module is mounted in the casing and connected to the I/O interface and has an inductor, an LED and a resistor. The inductor is connected to the I/O interface and has an input end and an output end. The LED is mounted on the casing and connected to the output end of the inductor. The resistor is connected in series with the LED. When the LED is not on, electrical power is not being provided to the proper pin on the I/O interface from the digital device. Consequently, any fault observed when the LED is not on can be attributed to a fault in the digital device.

### BACKGROUND OF THE INVENTION

1. Field of the Invention

The present invention relates to a memory card, and more particularly to a memory card with an indicator light to indicate whether or not the memory card is faulty.

2. Description of Related Art

Digital devices such as digital cameras, Personal Digital Assistants (PDA), and cellular telephones are used widely. Each digital device has a slot into which a memory card is plugged, and the memory card stores data.

Memory cards are manufactured in several types such as multimedia (MM) cards, secure digital (SD) cards, reduced size multimedia (RS-MM) cards, etc. for use in different types of digital devices. The types of memory cards have different standards that may have a different number of pins, different pinouts, different shapes or any combination of these features.

If the memory card does not work when plugged into the slot of the digital device and the digital device works normally, users are not able to ascertain easily whether the digital device or the memory card is faulty. Ways to find out the cause include plugging another memory card into the slot of the digital device or plugging the memory card into the slot of another digital device. Users are then able to assertion whether the fault is in the card or the digital device. However, most people do not have another memory card or digital device available to check for the source of the fault.

To overcome the shortcomings, the present invention provides a memory card with an indicator light to mitigate or obviate the aforementioned problems.

### SUMMARY OF THE INVENTION

The main objective of the invention is to provide a memory card with an indicator light to show whether or not the memory card is faulty.

A memory card with an indicator light in accordance with the present invention comprises a casing, a processor, an input/output (I/O) interface, memory and an indicator light module. The processor is mounted in the casing. The I/O interface is mounted in and exposed through the casing and connected to the processor. The memory is mounted in the casing and connected to the I/O interface and the processor. The indicator light module is mounted in the casing and connected to the I/O interface and comprises an inductor, an LED and a resistor. The inductor is connected to the I/O interface, may be formed on a ferrite bead and has an input end and an output end. The LED is mounted on the casing and connected to the output end of the inductor. The resistor is connected in series with the LED.

Other objectives, advantages and novel features of the invention will become more apparent from the following detailed description when taken in conjunction with the accompanying drawings.

### BRIEF DESCRIPTION OF THE DRAWINGS

FIG. 1A is a circuit diagram of an input/output (I/O) interface and a light indicator module for a memory card with an indicator light in accordance with the present invention;

FIG. 1B is a circuit diagram of a processor for the memory card with an indicator light in accordance with the present invention;

FIG. 1C is a circuit diagram of a memory chip for the memory card with an indicator light in accordance with the present invention;

FIG. 1D is a circuit diagram of another memory chip for the memory card with an indicator light in accordance with the present invention; and

FIG. 2 is a perspective view of a memory card with an indicator light in accordance with the present invention.

### DETAILED DESCRIPTION OF PREFERRED EMBODIMENT

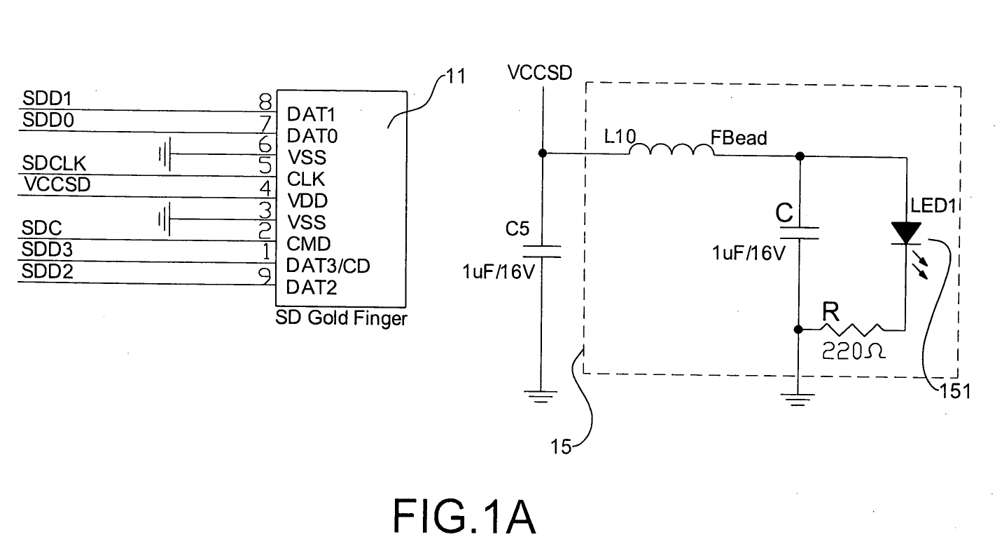

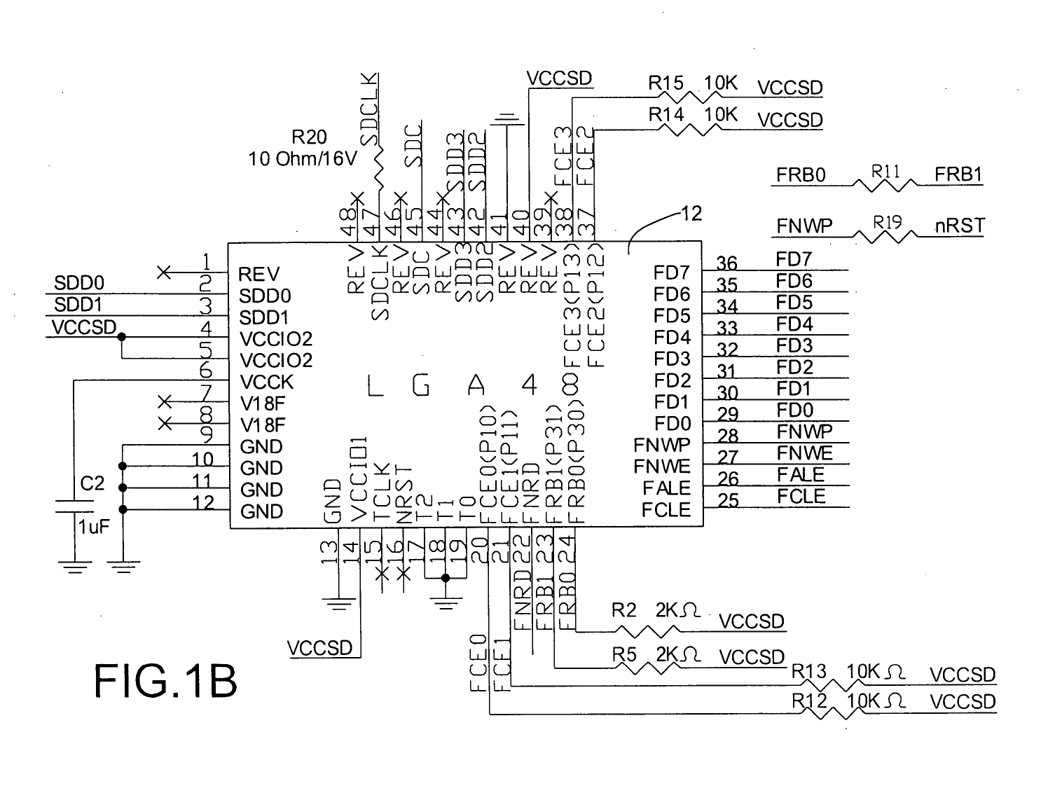

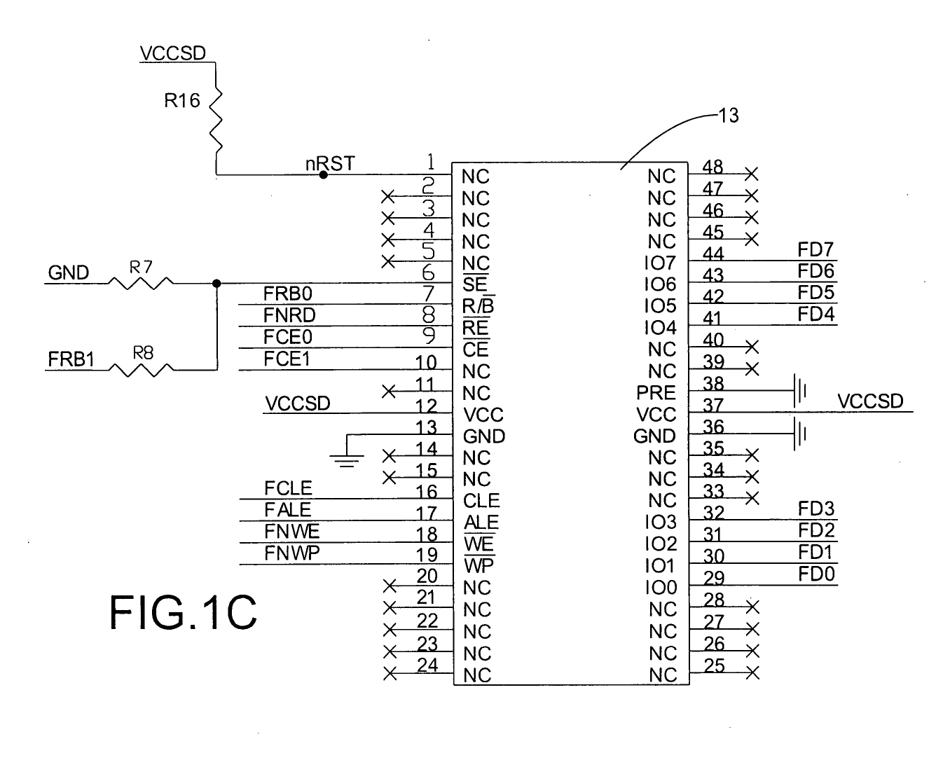

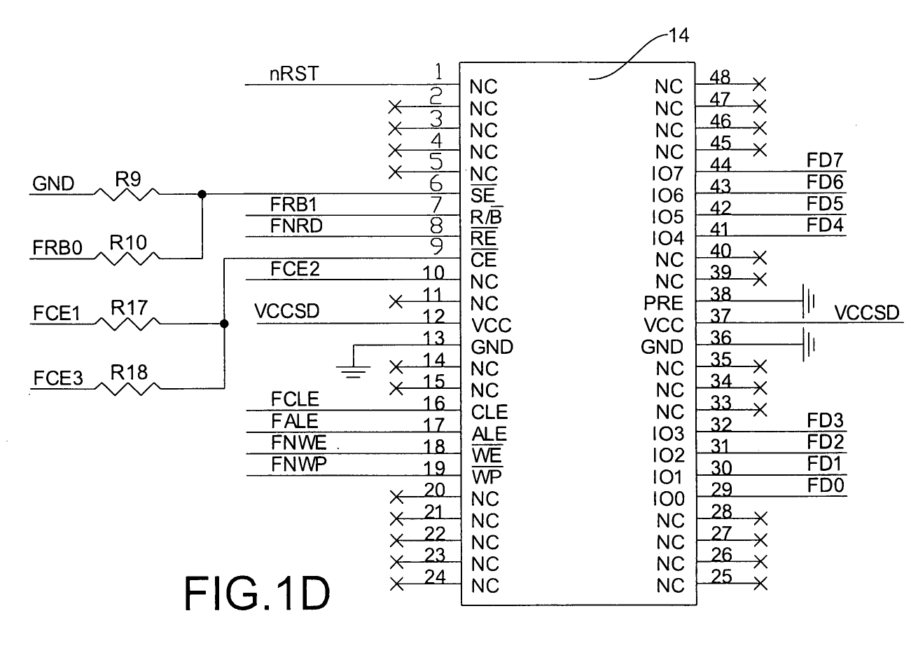

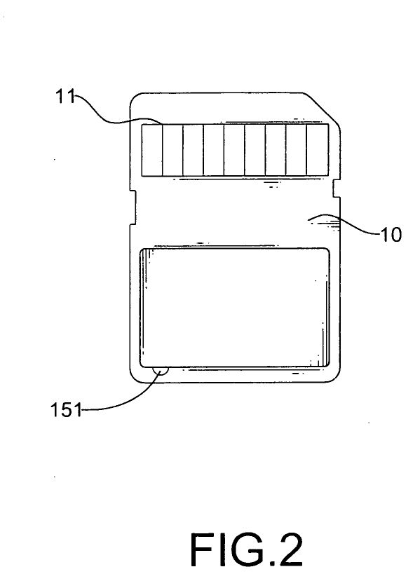

With reference to FIGS. 1A, 1B, 1C, 1D and 2, memory cards with an indicator light in accordance with the present invention are mounted detachably in digital devices (not shown) and comprise a casing (10), a processor (12), an input/output (I/O) interface (11), an optional capacitor (C5), memory and an indicator light module (15).

The processor (12) is mounted in the casing (10) and controls operation of the memory card.

The I/O interface (11) is mounted in and exposed through the casing (10), is connected to the processor (12), selectively connects to a digital device to transfer data (not shown) and obtain electrical power, can be a secure digital (SD), a multimedia (MM) or a reduced size multimedia (RS-MM) interface and has a specific pin (not numbered) to connect to a source of power in a digital device.

The capacitor (C5) is connected to the I/O interface (11) and grounds any non-dc components in the electrical power.

The memory is mounted in the casing (10), is connected to the I/O interface (11) and the processor (12) and can be flash memory. The flash memory may be implemented with one or more flash memory chips (13, 14).

The indicator light module (15) is mounted in the casing (10) in parallel with the capacitor (C5), is connected to and monitors an external power source in a digital device through the I/O interface (11) and comprises an inductor (L10), an LED (151), a resistor (R) and an optional capacitor (C).

The inductor (L10) is connected to the I/O interface (11), may be formed around a ferrite bead (FBead) and has an input end (not numbered) and an output end (not numbered). The input end is connected to the pin on the I/O interface (11), which connects to a power source in a digital device.

The LED (151) is mounted on the casing (10), is visible when the memory card is plugged into a digital device, is connected to the output end of the inductor (L10) and emits light when the correct pin on the I/O interface (11) obtains electrical power from a digital device.

The resistor (R) is connected in series with the LED (151).

The capacitor (C) is connected in parallel with the resistor (R) and the LED (151) to ground any non-dc components in the electrical power.

Any fault observed when the LED (151) is not on can be attributed to a fault in the digital device so people are able to ascertain easily whether the digital device or the memory card is faulty.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A memory card with an indicator light comprising:
a casing;
a processor mounted in the casing and controlling operation of the memory card;
an input/output (I/O) interface mounted in and exposed through the casing, connected to the processor and having specific pins to transfer data and obtain electrical power from a digital device;
memory mounted in the casing and connected to the I/O interface and the processor; and
an indicator light module mounted in the casing to monitor an external power source in a digital device through the I/O interface and comprising
an inductor connected to the I/O interface and having
an input end connected to the pin on the I/O interface,
which connects to a power source in a digital device; and
an output end;
an LED mounted on the casing, being visible when the memory card is adapted to be plugged into a digital device, connected to the output end of the inductor and emitting light when the correct pin on the I/O interface is adapted to obtain electrical power from the digital device; and
a resistor connected in series with the LED.

2. The memory card with an indicator light as claimed in claim 1, wherein the I/O interface is a secure digital (SD) interface.

3. The memory card with an indicator light as claimed in claim 1, wherein the I/O interface is a multimedia (MM) interface.

4. The memory card with an indicator light as claimed in claim 1, wherein the I/O interface is a reduced size multimedia (RS-MM) interface.

5. The memory card with an indicator light as claimed in claim 1, wherein the memory is flash memory.

6. The memory card with an indicator light as claimed in claim 5, wherein the flash memory is one flash memory chip.

7. The memory card with an indicator light as claimed in claim 5, wherein the flash memory is multiple flash memory chips.

8. The memory card with an indicator light as claimed in claim 1 further comprises a capacitor connected in parallel with the indicator light module to the I/O interface.

9. The memory card with an indicator light as claimed in claim 1, wherein the indicator light module further comprises a capacitor connected in parallel with the resistor and the LED.

10. The memory card with an indicator light as claimed in claim 1, wherein the inductor in the indicator light module is formed around a ferrite bead.
